(19) United States
(12) Patent Application Publication
(10) Pub. No.: US 2026/0093216 A1
(43) Pub. Date: Apr. 2, 2026

(54) ELECTRONIC DEVICE PLACED ON A VERTICAL SURFACE AND CONTROLLED BY MEANS OF A BRACKET

(71) Applicant: SMARTPOINT LIMITED LIABILITY COMPANY, Moscow (RU)

(72) Inventors: Tatiana Nikolaevna MOSALOVA, Moscow (RU); Artem Aleksandrovich KRAVCHENKO, Moscow (RU)

(21) Appl. No.: 18/945,540

(22) Filed: Nov. 13, 2024

(30) Foreign Application Priority Data
Sep. 30, 2024 (RU) 2024129099

(51) Int. Cl. G05B 15/02

(52) U.S. Cl. CPC G05B 15/02

(57) ABSTRACT

The proposed invention relates to the field of computer engineering and can be used to control electronic devices. An electronic device placed on a vertical surface and controlled by means of a bracket is proposed. The technical result achieved by implementing the claimed invention, in addition to the invention realizing its purpose, is the elimination of the disadvantages of analogues and thus ensuring the rapid disconnection of the bracket and the device placed on it, while ensuring the usual reliability of placing the device on a vertical surface. Another technical result achieved by implementing the claimed invention, in addition to the invention realizing its purpose, is also ensuring precise positioning of the device in space and ensuring a rapid change of its operating mode and/or settings.

### FIELD OF INVENTION

The proposed invention relates to the field of computer technology and can be used to control electronic devices.

### DESCRIPTION OF THE RELATED ART

Various methods are known for determining the position of a device in space, such as those described in patent documents US20150331084A1 (D1), U.S. Pat. No. 9,681,267B2 (D2), and U.S. Pat. No. 11,051,105B2 (D3).

A common disadvantage for the means of determining the device location in space known from the prior art is their low accuracy, and the inability to determine the purpose of the room in which the device is located, and that does not allow using these methods to control the device depending on the environment of its use.

Thus, there is a problem of providing a simple and fast way to control an electronic device depending on the environment of its use.

The D3 solution can be used as the closest analog.

### SUMMARY OF THE INVENTION

The technical problem solved by the claimed invention is the implementation of brackets, and/or systems, and/or sets, and/or products, and/or devices that do not have the disadvantages of prior art, i.e., that ensure rapid disconnection of the bracket and the device placed on this bracket. Another technical problem solved by the claimed invention is the creation of brackets, and/or systems, and/or sets, and/or devices that do not have prior art disadvantages, providing rapid disconnection of the bracket and the device to quickly change the operation mode of the device and/or its settings, which may be suitable, for example, without limitation, for precise positioning of the device within the environment of use, and changing the operating mode of the device and/or its settings depending on the environment of use. Another technical problem solved by the claimed invention is the expansion of the following technical means: brackets for electronic devices placed on vertical surfaces and/or electronic devices capable of changing their operating mode and/or their settings depending on the environment of use.

In addition to the implementation of the invention's purpose, the technical result achieved by the claimed invention is to eliminate the disadvantages of analogs and thus provide rapid disconnection of the bracket and the device placed on it, ensuring the usual reliability of placing the device on a vertical surface. Another technical result achieved in the implementation of the claimed invention, in addition to the implementation of its purpose, is to ensure accurate positioning of the device in space and to allow rapid changes in its operating mode and/or settings.

The technical result is achieved due to the fact that an electronic device placed on a vertical surface and controlled by means of a bracket, containing, at least, a reader designed to interact with a passive means of identification of the bracket, a processor, a memory containing at least a program code, which, when executed by the processor, ensures interaction of the reader with the passive means of identification to receive an identification signal; wherein, the electronic device is designed to be placed on a vertical surface using a bracket; wherein, a recess is made in a side of the electronic device facing the vertical surface for a protrusion formed by the bracket; wherein, the bracket for the electronic device placed on the vertical surface is an element fixed on a vertical surface forming the protrusion that can be placed in a recess facing the vertical surface of the side of the electronic device; wherein, the protrusion contains at least one ferromagnetic or magnetic element, and a corresponding opposing magnetic or ferromagnetic element is placed in the recess in such a way that, when placing the protrusion in the recess, it contacts the corresponding ferromagnetic or magnetic element of the bracket to form a magnetic connection; wherein, the recess is made in such a way as to ensure shifting of the corresponding opposing magnetic or ferromagnetic element relative to the corresponding ferromagnetic or magnetic element.

### BRIEF DESCRIPTION OF THE DRAWINGS

Illustrative embodiments of the claimed invention are described in detail below with reference to the attached drawings, which are included in this document by reference, containing:

FIG. 1 shows one approximate implementation of the claimed bracket 100, as an example, but not a limitation.

FIG. 2 shows one approximate version of the device 200 connected to the bracket 100, as an example, but not a limitation.

FIG. 3 shows another approximate version of the device 200 connected to the bracket 100, as an example, but not a limitation.

FIG. 4 shows approximate connection options of the bracket 100 and the device 200, as an example, but not a limitation.

FIG. 5 shows approximately how the bracket 100 is placed in the recess 202 of the device 200, as an example, but not a limitation.

FIG. 6 shows another approximate implementation of the claimed bracket 100, as an example, but not a limitation.

FIG. 7 shows one approximate version of the device 200 connected to the bracket 100 according to the second embodiment, as an example, but not a limitation.

FIG. 8 shows an approximate embodiment of the ferromagnetic element 201 (not shown in this drawing) shift relative to the magnetic element 101 in one version of the device 200 when using the bracket 100 in the second embodiment, as an example, but not a limitation.

FIG. 9 shows an approximate embodiment of the ferromagnetic element 201 (not shown in this drawing) shift relative to the magnetic element 101 in another version of the device 200 when using the bracket 100 in the second embodiment, as an example, but not a limitation.

FIG. 10, shows a rear view for two approximate embodiments of the device 200, intended for use with the bracket 100 in the first embodiment, as an example, but not a limitation.

FIG. 11 shows a rear view for two approximate embodiments of the device 200, intended for use with the bracket 100 in another embodiment, as an example, but not a limitation.

FIG. 12 shows an approximate diagram of the proposed system 500, as an example, but not a limitation.

### DETAILED DESCRIPTION OF THE PREFERRED EMBODIMENTS

In the preferred embodiment of the present invention, a bracket for an electronic device placed on a vertical surface is provided, which is an element fixed to a vertical surface with the formation of a protrusion, made with the possibility of placing a protrusion in a recess made from the side of the electronic device facing the vertical surface; wherein, the protrusion contains at least one ferromagnetic or magnetic element, and a corresponding opposing magnetic or ferromagnetic element is placed in the recess in such a way that, when placing the protrusion in the recess, it contacts the corresponding ferromagnetic or magnetic element to form a magnetic connection; wherein, the recess is made in such a way as to ensure the shift of the corresponding opposing ferromagnetic or magnetic element relative to the corresponding magnetic or ferromagnetic element of the bracket; wherein, the bracket is equipped with a passive means of identification, and an electronic device is equipped with a reader made with the possibility of interacting with the said means of identification; wherein, the electronic device contains at least: a processor; memory, at least containing a program code, which, when executed by the processor, ensures the interaction of the said reader with the said means of identification to receive an identification signal.

In a particular embodiment of the present invention, the mentioned bracket is provided, characterized in that the electronic device is an acoustic device containing additionally, at least, a processor-controlled audio output device.

In a particular embodiment of the present invention, the mentioned bracket is provided, characterized in that the electronic device is a lighting device containing additionally, at least, a processor-controlled light source.

In a particular embodiment of the present invention, the mentioned bracket is provided, characterized in that the electronic device is an IoT device containing additionally, at least, a receiver controlled by a processor, and a transmitter able to send a control signal.

In a particular embodiment of the present invention, the mentioned bracket is provided, characterized in that the electronic device is an image output device containing additionally, at least, a processor-controlled display.

In a particular embodiment of the present invention, the mentioned bracket is provided, characterized in that the memory additionally contains at least a program code, which, when executed by the processor, changes, in response to the received identification signal, the operating mode of the electronic device and/or the settings of the electronic device.

In another preferred embodiment of the present invention, the said electronic device is provided, containing, at least: a reader designed to interact with a passive means of identification of the bracket (not shown in the drawings), a processor, a memory containing at least a program code, which, when executed by the processor, ensures the interaction of the said reader with the said means of identification to receive an identification signal; wherein, the electronic device is designed to be placed on a vertical surface using a bracket; wherein, a recess is made from the side of the electronic device facing the vertical surface for the protrusion formed by the bracket; wherein, the bracket for the electronic device placed on the vertical surface is an element fixed on a vertical surface forming a protrusion that can be placed in a recess facing the vertical surface of the side of the electronic device; wherein, the protrusion contains at least one ferromagnetic or magnetic element, and a corresponding opposing magnetic or ferromagnetic element is placed in the recess in such a way that, when placing the protrusion in the recess, it contacts the corresponding ferromagnetic or magnetic element of the bracket to form a magnetic connection; wherein, the recess is made in such a way as to ensure the shift of the corresponding opposing ferromagnetic or magnetic element relative to the corresponding magnetic or ferromagnetic element.

In another preferred embodiment of the present invention, a method of control of an electronic device placed on a vertical surface is provided, wherein the said electronic device is placed on the bracket so as to allow the interaction with a passive means of identification of the bracket to receive the identification signal, and in response to the signal, change the operation mode of the electronic device and/or change the settings of the electronic device; and the said bracket is fixed on a vertical surface with the formation of the protrusion that can be placed in the recess facing vertical surface side of the electronic device; wherein the protrusion comprises at least one ferromagnetic or magnetic element and the recess comprises the corresponding opposing magnetic or ferromagnetic element so that when placing the protrusion in the recess, the magnetic connection is formed; and the recess is formed so as to provide the appropriate opposing shift of the ferromagnetic or magnetic element relative to the corresponding magnetic or ferromagnetic element of the bracket; the bracket is equipped with a passive means of identification, and the electronic device is provided with at least a reader, configured to interact with said means of identification; wherein the electronic device also includes, at least a processor; memory that contains at least the program code, which when executed by the processor, provides the interaction of the mentioned reader with the means of identification to receive identification signal.

The following are the embodiments of the present invention, disclosing examples of its specific implementations. However, the description is not intended to limit the scope of the rights granted by this patent. Rather, it should be assumed that the claimed invention can also be implemented in other ways that it will include different elements and conditions or combinations of elements and conditions similar to the elements and conditions described in this document, in combination with other existing and future technologies.

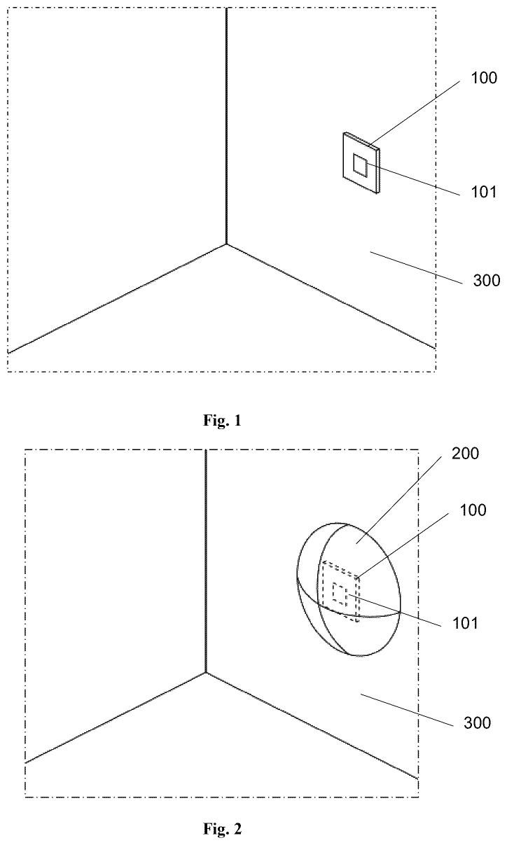

FIG. 1 shows one approximate implementation of the claimed bracket 100, as an example, but not a limitation. Preferably, without limitation, in one embodiment, the claimed bracket 100 is a parallelepiped with one side facing a vertical surface 300, such as, for example, without limitation, a wall of a room or building, a pillar, etc., while the surface 300 contains enough space for reliable placement of the bracket 100 on the surface 300. In this case, for example, without limitation, the bracket 100 can be fixed to the surface 300 in any known or future-known suitable way that provides a sufficiently reliable connection of the bracket 100 to the surface 300, such as, for example, but not limited to, a threaded connection, such as, for example, but not limited to, an anchor, and/or threaded and/or screw connection, as well as, without limitation, gluing, welding and etc. In addition, for example, without limitation, when the surface 300 is made of a ferromagnetic or contains a ferromagnetic region, the bracket 100 on the reverse side can be equipped with an additional magnetic element (not shown in the drawing) for reliable connection to the ferromagnetic surface 300 or its ferromagnetic part. For example, without limitation, a section of soft iron (magnetic wallpaper) and the like can be fixed on the surface 300 as a ferromagnetic region. In this case, without limitation, fixing the bracket 100 to the surface 300 by means of an anchor or threaded connection, the bracket 300 can be provided with appropriate holes through which the bracket 100 is fixed to the surface by means of a screw, including a self-tapping screw. In the case of a welded joint, the bracket 100, for example, without limitation, is made of metal, or at least contains a metal base (not shown in the drawing) of sufficient thickness suitable for forming a welded joint with a metal surface 300 or a metal portion of the surface 300. In the case of gluing, for example, without limitation, the bracket 100 has an adhesive base on the reverse side (not shown in the drawing), for example, without limitation, in the form of double-sided adhesive tape, and the surface 300 is selected such that sufficient adhesion of the tape base to the surface 300 is ensured; in addition, without limitation, the bracket 100 can be made of a material or have a base (not shown in the drawing), with the adhesion to the glue used for gluing approximately corresponding to the adhesion of the same glue to the surface 300. Thus, without limitation, fixing the bracket 100 to the surface 300 can be carried out in any suitable known or future method, which are not described in more detail further. It should be assumed that the bracket 100 necessarily forms a protrusion, when fixed to the surface 300. In this case, without limitation, the protrusion can be formed either directly by the housing of the bracket 100, or by any part protruding from the housing (not shown in the drawing). In this case, preferably, without limitation, the bracket 100 and the formed protrusion contain at least one magnetic element 101, which is the main magnetic element of the bracket 100. Preferably, without limitation, the magnetic element 101 does not occupy the entire surface of the formed protrusion, but is positioned in such a way as to ensure a reliable magnetic connection with the opposing ferromagnetic element 201 in the recess 202 of the device 200, which will be described in detail below, but at the same time it is possible to shift the ferromagnetic element 201 relative to the magnetic element 101 to ensure their rapid and convenient separation; without limitation, this is mainly due to the fact that much more strength is required to break the magnetic connection than to shift the magnets, which is especially important when using a powerful magnet as a magnetic element 101, such as, for example, without limitation, a neodymium magnet, which will inevitably require shifting to separate the elements successfully.

FIG. 2 shows one approximate version of the device 200 connected to the bracket 100, as an example, but not a limitation. Preferably, without limitation, a device 200 is predominantly of any suitable shape or size, the choice of which is mainly due to the strength and reliability of the magnetic connection provided, and the strength and reliability of the connection of the bracket 100 to the surface 300. Wherein, without limitation, in this embodiment, the device 200 is not predominantly flat, i.e., the thickness of the product's protruding part above the formed bracket 100 from the surface 300 is at least twice the thickness of a formed protrusion. Wherein, without limitation, the shape of such a device 200 is mainly determined by its purpose.

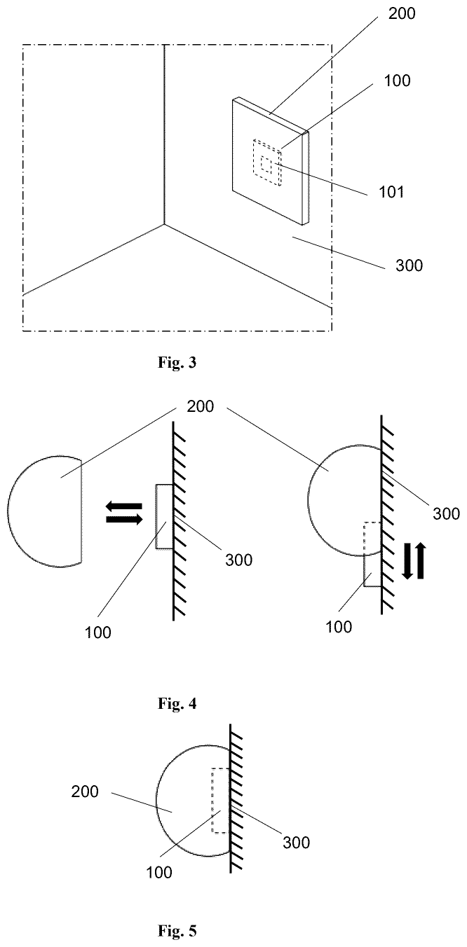

FIG. 3 shows another approximate version of the device 200 connected to the bracket 100, as an example, but not a limitation. Preferably, without limitation, in another embodiment, the device 200 is predominantly flat, i.e., the thickness of the product's protruding part formed by the bracket 100 from the surface 300 does not exceed the thickness of the formed protrusion by more than two times. Wherein, without limitation, the shape of such a device 200 is mainly determined by its purpose.

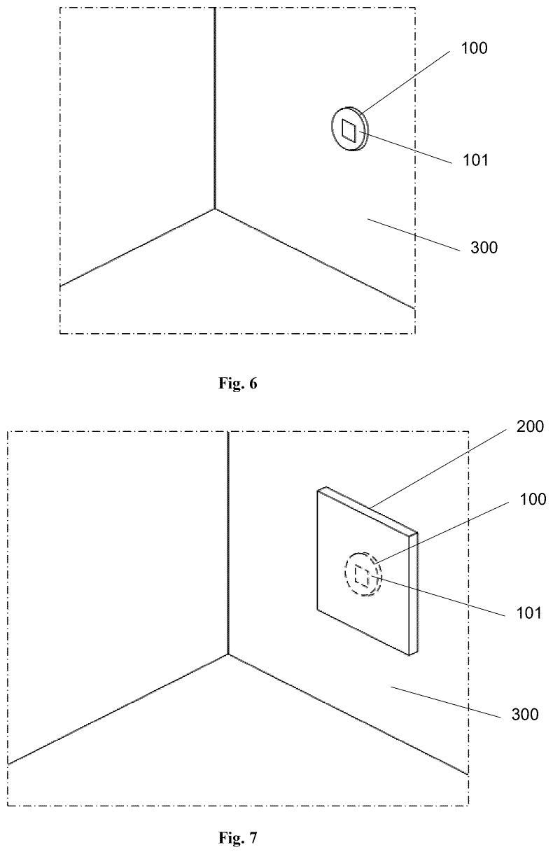

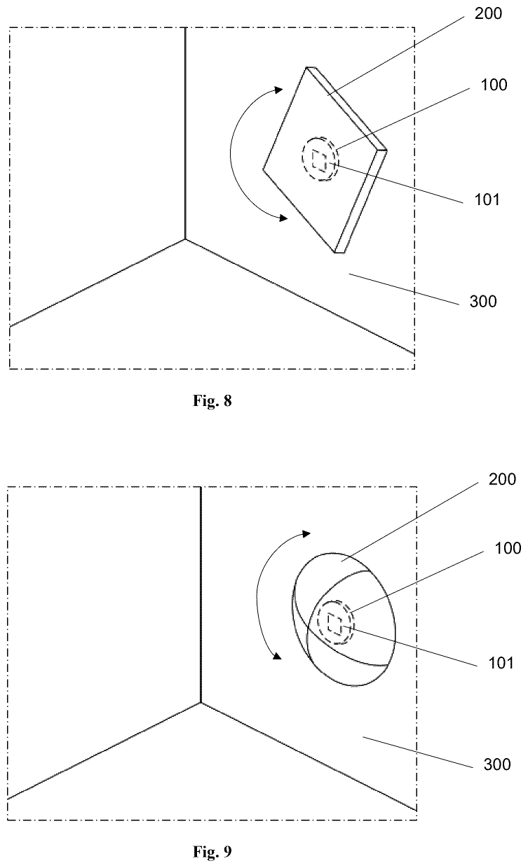

FIG. 4 shows approximate connection options for the bracket 100 and the device 200, as an example, but not a limitation. As will be shown below, the device 200 may contain a recess 202, in which the protrusion formed by the bracket 100 is located. Without limitation, it is possible to provide two connection options. According to the first option, without limitation, as shown in the left part of FIG. 4, it is ensured that the device 200 is fitted with a recess 202 in a horizontal direction towards the surface 300 on the protrusion formed by the bracket 100; in this case, the recess 202 in the device 200 is made in such a way that it has all the walls and does not allow shifting of the device 200 relative to the bracket 100 in any direction. Accordingly, without limitation, in order to disconnect the device 200 and the bracket 100, it is necessary to at least rotate the device 200 along an axis perpendicular to the surface 300, as will be shown below. According to the second option, without limitation, as shown in the right part of FIG. 4, it is ensured that the device 200 is fitted with a recess 202 in a horizontal or vertical direction parallel to the surface 300 on the protrusion formed by the bracket 100; in this case, the recess 202 in the device 200 is made in such a way that it does not have one of the walls and allows the device 200 to shift relative to the bracket 100 in the direction of the missing wall. Accordingly, without limitation, in order to disconnect the device 200 and the bracket 100, at least the device 200 should be moved in the direction opposite to the missing wall, i.e., if the wall of the recess 202 is missing from below, then the device 200 should be moved up, allowing the shift to happen. FIG. 5 shows approximately how the bracket 100 is placed in the recess 202 of the device 200, as an example, but not a limitation. Wherein, without limitation, although not shown in the drawing, it should be obvious to a specialist in this field of technology with ordinary knowledge, for whom the present invention is designed, that it is not necessary that the back wall of the device 200 contains a recess 202, and a base can be formed in the device 200, which will contain a suitable recess 202.

Wherein, it should be obvious to a specialist in this field of technology with ordinary knowledge, for whom the present invention is designed, that when the recess 202 follows the shape and size of the bracket 100, and, at the same time, the bracket 100 has angles, then shifting by rotation will be difficult or even impossible. FIG. 6 shows another approximate implementation of the claimed bracket 100, as an example, but not a limitation. Unlike the variant discussed earlier with reference to FIG. 1, the bracket 100 with reference to FIG. 6 is at least not rectangular, as shown in FIG. 1. Such a bracket 100 according to FIG. 6 is connected to the device 200 in the same way as shown with reference to FIG. 5 (left part), and differs in its functionality only in that its shape and size allows to rotate the recess 202 around the protrusion formed by the bracket 100. Without limitation, such a bracket 100 can be additionally equipped with a positioning tool, for example, a small recess in the surface of the bracket 100, into which an oncoming small protrusion falls; the protrusion is made on the surface of the recess 202 in contact with the surface of the bracket 100 (not shown in the drawing); such a positioning tool can be used to accurately position the device 200 relative to the surface 300. As an example, but not a limitation, FIG. 7 shows one approximate version of a predominantly flat device 200 connected to the bracket 100 as shown in FIG. 6. As an example, but not a limitation, FIG. 8 shows an approximate embodiment of the metal element 201 (not shown in this drawing) shift relative to the magnetic element 101 in the version of the device 200 from FIG. 7, using the bracket 100 shown in FIG. 6. As an example, but not a limitation, FIG. 9 shows an approximate embodiment of the ferromagnetic element 201 (not shown in this drawing) shifting relative to the magnetic element 101 in another version of the device 200, when using the bracket 100 as shown in FIG. 6.

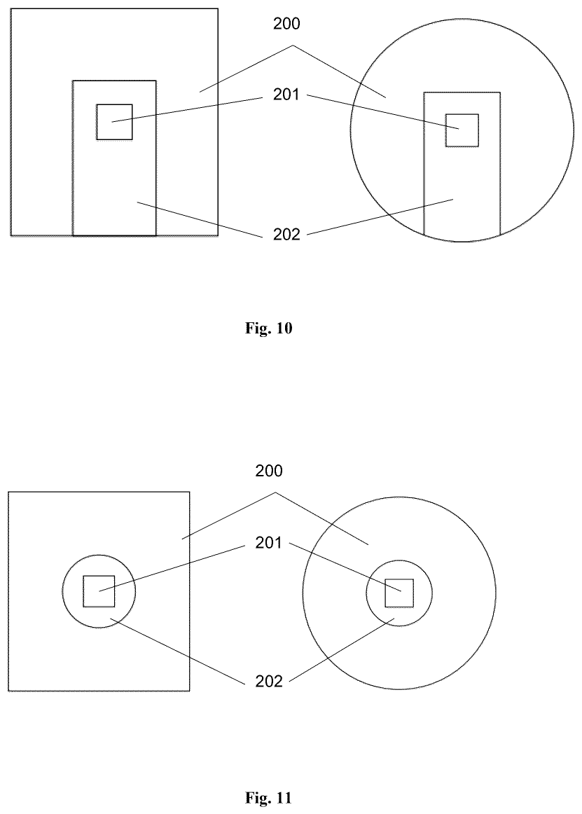

As an example, but not a limitation, FIG. 10 shows a rear view for two approximate embodiments of the device 200, intended for use with the bracket 100 as shown in FIG. 1. Wherein, without limitation, as mentioned earlier, the shape of the device 200 is not essential, since its choice may be determined by the purpose of the product, but the rear part of the device 200 or the rear part of the base of the device 200 should contain a recess 202 in which a ferromagnetic element 201 is placed, which is opposed to the magnetic element 101. Such a recess 202, although not shown, obviously does not have one of the walls and thus provides at least the possibility of shifting the ferromagnetic element 201 relative to the magnetic element 101 in a horizontal or vertical direction parallel to the surface 300; wherein, a specialist in this field of technology with ordinary knowledge, for whom the present invention is intended, should obviously see that if the size of the bracket 100 allows this, then a shift can be provided by rotating the recess 202 around the protrusion formed by the bracket 100; wherein, it should be obvious to a specialist in this field of technology with ordinary knowledge, for whom the present invention is designed, that the device 200 can be placed on two or more brackets 100, which may be due to the size of the device 200, and it should be assumed that such brackets 100 should be placed coaxially on the surface 300 in such a way that all ferromagnetic elements 201 are simultaneously shifted relative to all corresponding magnetic elements 101. As an example, but not a limitation, FIG. 11 shows a rear view for two approximate embodiments of the device 200, intended for use with the bracket 100 as shown in FIG. 6. In contrast to what has been said with reference to FIG. 10, the recesses 202 in this case have all walls and are essentially circular or shaped in such a way that the ferromagnetic element 201 is shifted relative to the magnetic element 101 solely by rotating the recess 202 around the protrusion formed by the bracket 100.

Wherein, it should be obvious to a specialist in this field of technology with ordinary knowledge, for whom the present invention is designed, that the magnetic element 101 and the ferromagnetic element 201 can be swapped, i.e., that the device 200 contains a magnetic element 101, and the bracket 100 contains a ferromagnetic element 201. Wherein, without limitation, the device 200 can have its own magnetic element, and the magnetic element 101 remains in the bracket 100, and such magnetic elements are opposite, which ensures their attraction to each other and can provide a more reliable connection than that between a magnet and a ferromagnetic.

Wherein, without limitation, a bracket 100 can be provided for an electronic device 200 placed on a vertical surface, which is an element fixed to a vertical surface with forming a protrusion, made with the possibility of placing a protrusion in a recess 202 made from the side of the electronic device 200 facing the vertical surface; also, the protrusion contains at least one ferromagnetic or magnetic element 101, and a corresponding opposing magnetic or ferromagnetic element 201 is placed in the recess in such a way that, when placing the protrusion in the recess 202, it contacts the corresponding ferromagnetic or magnetic element 101 to form a magnetic connection; wherein, the recess 202 is designed in such a way as to ensure the shift of the corresponding opposing ferromagnetic or magnetic element 201 relative to the corresponding magnetic or the ferromagnetic element 101; also, the bracket 100 is equipped with a passive means of identification (not shown in the drawings), and the electronic device 200 is equipped with a reader 203, designed to interact with the said means of identification; wherein, the electronic device 200 contains at least the following: processor 204; memory 205 with at least the program code which, when executed by the processor 204, ensures the interaction of the said reader 203 with the said means of identification to obtain an identification signal.

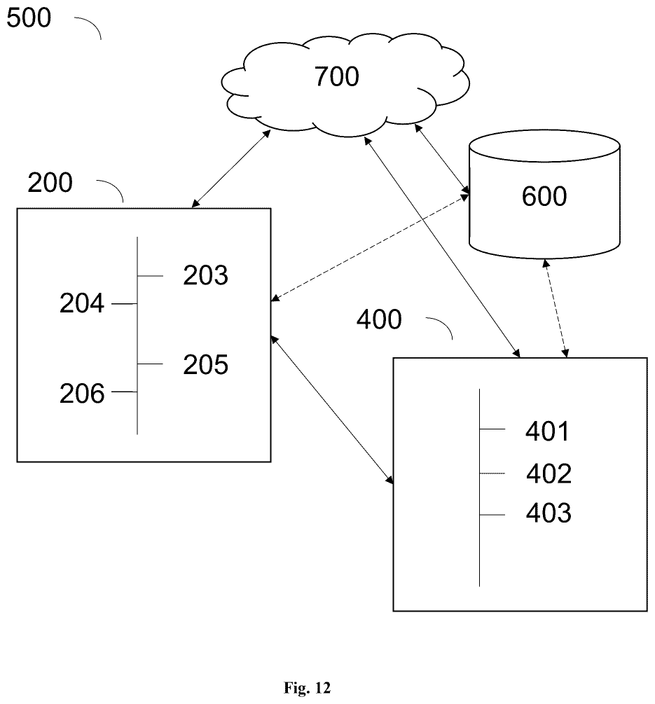

Therefore, without limitation, the above-mentioned electronic device 200 can be provided, an approximate diagram of which is shown in FIG. 12, containing, at least, the reader 203, made with possibility of interaction with the passive means of identification (not shown), a processor 204, a memory 205 with at least a program code, which, when executed by the processor 204 provides the interaction of the mentioned reader 203 with the above-mentioned means of identification to receive the identification signal; wherein the electronic device 200 is designed to be placed on a vertical surface using the bracket 100; also, facing vertical surface side of the electronic device 200, a recess 202 is formed for the bracket 100 protrusion; the bracket 100 is placed on the vertical surface of the electronic device 200 is an element fixed on the vertical surface forming a protrusion; the protrusion can be placed in the electronic device 200 recess 202 facing the vertical surface side of the electronic device; wherein the protrusion comprises at least one ferromagnetic or magnetic element 101 and the recess 202 comprises the corresponding opposing magnetic or ferromagnetic element 201 so that when placing the protrusion in the recess 202, a magnetic connection is formed; wherein, the recess 202 is formed so as to provide the appropriate opposing shift of the ferromagnetic or magnetic element 201 relative to the corresponding magnetic or ferromagnetic element 101.

Wherein, without limitation, the electronic device 200 can be selected from or can be formed from any combination of the following: an acoustic device 200, a lighting device 200, an IoT device 200, and an image output device 200. Wherein, without limitation, the acoustic device 200 additionally contains at least a device for sound output, such as, without limitation, a speaker, the use of which for sound output is widely known from the state of the art and is not described in detail further. Without limitation, the lighting device 200 additionally contains at least a light source, such as, without limitation, an LED light source etc., the use of which for lighting is widely known from the state of the art and is not further described in detail further. Wherein, without limitation, the IoT device 200 additionally contains at least a receiver, a transmitter able to send a control signal; wherein, it should be assumed that the IoT device 200 for the bracket 100 can be both a repeater and a hub, or can be equipped with hub functions, i.e., for example, without limitation, memory may include program code for generating a control signal for other devices in the IoT system in response to the received identification signal; also, the principles of organizing IoT systems are widely known from the state of the art and are not described in detail further. Wherein, without limitation, the image output device 200 additionally contains at least a display, the use of which for image output is widely known from the state of the art and is not described in detail further.

Wherein, without limitation, one element or any combination of the following: a two-dimensional graphic code, such as, for example, a quick response code (QR code), or a barcode, or an RFID tag, can be selected as a passive means of bracket identification. Wherein, depending on which passive means of identification is used in the bracket 100, the electronic device 200 includes a suitable reader 203. For example, without limitation, when a two-dimensional graphic code is selected as a passive means of identification, the reader 203 may be a laser scanner or a video scanner, which are widely known from the state of the art and are not described in detail further. For example, without limitation, when an RFID tag is selected as a passive means of identification, the reader 203 may be, for example, an NFC module, which is widely known from the state of the art and is not described in detail further. Preferably, without limitation, the reader 203 interacts with the corresponding passive identification means when the magnetic connection is established. Wherein, without limitation, an electric switch can be provided, which is triggered when the magnetic connection is formed, and thus ensures the operation of the reader 203; or, for example, without limitation, a means of positioning the electronic device 200 in space, such as, for example without limitation, a gyroscope, a certain position of which signals the need to activate the reader 203 and corresponds to the position of the electronic device 200 in the position in which the magnetic connection is formed; or, as part of the bracket 100, an additional power source connected to the electrical network for the battery of the electronic device 200 can be provided, for example, without limitation, a power supply for the battery of the electronic device 200, for which electrical contacts can be provided on the surface of the bracket 100 to create an electrical connection when the magnetic connection is formed, for which, for example, without limitation, opposite electrical contacts connected to the power controller can also be provided in the recess 202; when an electrical connection is formed, not only can the capacity of the batteries of the electronic device 200 be replenished from an electrical network, but a signal can also be generated to activate the reader 203. Also, it should be obvious to a specialist in this field of technology with ordinary knowledge, for whom the present invention is designed, that an electronic device necessarily has one or more batteries, such as electric batteries, including disposable and/or rechargeable batteries and/or accumulators of electric energy, i.e., the presence of a battery in an electronic device 200 is immanent. Wherein, it should also be obvious to a specialist in this field of technology with ordinary knowledge, for whom the present invention is designed, that the electronic device has a suitable housing that protects the components of the device from external influences and/or unauthorized access, i.e., the presence of a housing for the electronic device 200 is immanent.

Wherein, without limitation, the electronic device 200 may be equipped with a means of wireless communication or another interface for connecting a user device 400 to it for initial configuration. The user device 400 in this case may be, but is not limited to, a smartphone, tablet computer, laptop, personal computer, and the like. Such a user device 400 typically contains at least input/output devices 401, such as, for example, a keyboard, manipulators, displays, including touch displays; processor 402, memory 403 containing program code that provides at least a configuration package to the electronic device 200. Preferably, without limitation, the configuration package thus includes at least the unique identifier of the bracket 100 and the scenarios and/or settings associated with this unique identifier for execution and/or application by the electronic device 200; wherein, without limitation, the electronic device 200 may thus contain in memory 205 the corresponding primary settings in the form of, for example, but not limited to, a set of unique identifiers of the brackets 100, each of which is associated with a corresponding scenario and/or settings for execution and/or application of the electronic device 200. The mentioned primary settings can be changed by the corresponding configuration package generated and transmitted to the electronic device 200 via the user device 400. However, without limitation, the use of the user device 400 is optional, and the electronic device 200 can be equipped with input/output devices 206, such as, for example, without limitation, keys, buttons, keyboard, manipulator, display, including touch screen, voice interface and the like. In this case, scenarios can be set and settings can be made for each bracket 100 directly when the user interacts with the electronic device 200, without using the user device 400.

Thus preferably, without limitation, as shown in FIG. 12, a system 500 can be provided for controlling an electronic device 200, which can additionally include a server, for example, without limitation, made on the basis of a user device 400, or made by a separate device 400. Wherein, the processor 204, 402, preferably, without limitation, means both the chip itself and other components of the processor and/or microprocessor architecture, such as, for example, without limitation, microcontrollers, drivers, cache memory and similar electronic devices; mainly it should be assumed that the processor provides the implementation of the program code that ensures the implementation of any operating scenario and/or the application of any settings by the electronic device 200. Wherein, as an example, but not a limitation, memory 205, 403 (machine-readable data carrier 205, 403) may include non-volatile memory (NVRAM); random access memory (RAM); permanent storage device (ROM); electrically erasable programmable permanent storage device (EEPROM); flash memory or other memory technologies; CDROM, digital versatile disk (DVD) or other optical or holographic data carriers; magnetic cassettes, magnetic film, magnetic disk storage device or other magnetic storage devices; as well as any other data carrier that can be used to store and encode the required information. Wherein, without limitation, memory 205, 403 includes a data carrier based on a computer storage device in the form of volatile or non-volatile memory, or a combination thereof. Wherein, without limitation, approximate hardware devices include solid-state memory, hard disk drives, optical disk drives, and so on. Wherein, without limitation, the machine-readable data carrier 205, 403 (memory 205, 403) is not temporary (permanent, non-transitive), so that it does not include a temporary (transitive) propagating signal. Wherein, without limitation, an approximate environment can be stored in memory 205, 403, in which, using computer commands or codes, including those stored in memory 403 of the server 400, the procedure for forming a configuration package for its transfer to an electronic device 200 can be carried out. Wherein, without limitation, the system 500 may also include a database (DB) 600. DB 600 can be, but is not limited to, a hierarchical database, a network database, a relational database, an object database, an object-oriented database, an object-relational database, a spatial database, a combination of these two or more databases, and the like. Wherein, the DB 600, at least, stores the unique identifiers of the brackets 100 and the associated primary settings, including modified primary settings, that is, current settings, of the corresponding electronic devices 200, and can also store data for analysis, prerecorded scripts and other information in memory 205, 403 or in a suitable memory of another computer device connected to the electronic device 200 and/or to the server 400, which may be, but is not limited to, memory similar to any memory 205, 403, as previously shown, and which can be accessed via the server 400 and the network 700. In addition, without limitation, a server 400 is provided, which, in addition to the functions described earlier, stores and facilitates the manipulation of computer commands or codes previously described in this document, which, accordingly, are not described further. Wherein, without limitation, the server 400 can provide regulation of data exchange in the system 500, in addition to the functions described earlier. Wherein, without limitation, data exchange within the system 500 is carried out through one or more data transmission networks 700. Wherein, without limitation, data transmission networks 700 may include, but are not limited to, one or more local area networks (LAN) and/or wide area networks (WAN), or may be an information and telecommunications network Internet, or Intranet, or virtual private network (VPN), or a combination thereof, and the like. Wherein, without limitation, the server 400 also has the ability to provide a virtual computing environment to ensure interaction between system components. Wherein, without limitation, the network 700 is used to provide communication between the electronic device 200, the user device 400 and/or the server 400, and optionally the database 600. Wherein, without limitation, the database 600 can be implemented in memory 205, 403. Typically, without limitation, the components of the electronic device 200, the components of the user device 400, and the server 400 are interconnected, including through some kind of data bus.

Preferably, without limitation, the proposed system works as follows. Several brackets 100 with a passive means of identification are placed on a vertical surface 300 in one or more rooms or outdoors. The scenarios of operation and/or settings of the corresponding electronic devices 200 are primarily set via the user device 400 and/or the system 500; wherein, the scripts and/or settings are set in relation to the corresponding brackets 100; wherein, without limitation, the primary settings can be obtained from the database 600, or initially be stored in memory 205 of the electronic device 200, for example, in the case when the electronic device 200 is supplied as part of a set with several brackets 100. By placing the brackets 100, it is possible to accurately determine in which environment the electronic device 200 will be located, which allows to provide the most user-friendly operating mode and/or settings for the electronic device 200. Wherein, without limitation, the operating mode may also include a specific operating scenario, i.e., a one-time or repetitive sequence of procedures and/or operations performed by the electronic device 200. Accordingly, without limitation, when placing the electronic device 200 on the bracket 100, preferably when the magnetic connection is formed, the reader 203 is activated, which interacts with the passive identification means of the bracket 100 to receive an identification signal, in response to which a change in the operating mode of the electronic device and/or a change in the settings of the electronic device 200 is provided. When the electronic device 200 is disconnected from the bracket 100, for example, without limitation, it can continue to operate in the mode and with settings corresponding to the last bracket 100 from which the device 200 was disconnected, or the operating mode and/or settings can be changed at the time of disconnection, i.e., at the time of the magnetic connection termination. Then the device 200 can be placed on another bracket 100, with a unique identifier associated with a different operating mode and settings. Thus, it is possible to easily change the operating modes of the same electronic device, depending on user preferences and/or depending on the environment of the device 200 use. For example, without limitation, in the case of an acoustic device 200, one bracket 100 can initiate playback by the media player subroutine of an acoustic device of one sequence of musical content and with one sound level; but when connecting the device 200 to another bracket 100, another sequence of playback of other musical content and with a different sound level will be provided; that is, you can first place the device 200 on the bracket 100, for example, in the gym, and start playing loud music for training, and then you can place the device 200 on the bracket 100 in the living room, and ensure that quiet and calm music is played. Appropriate scenarios and settings can be also implemented for the lighting device 200, the IoT device 200, and the image output device 200; wherein, for example, without limitation, when the electronic device 200 is an IoT device 200, a control signal can be generated or at least transmitted which will provide a change in the operating modes and/or settings of other devices in the IoT system, i.e., for the IoT device 200, a change in the operating mode and/or settings may consist in, for example, without limitation, transmitting or generating and transmitting a control signal for other IoT devices in the IoT system.

Thus, a set may also be provided that includes at least some previously mentioned bracket 100 and at least some previously described device 200.

Thus, a method of control of an electronic device placed on a vertical surface can be provided, wherein the said electronic device 200 is placed on the bracket 100 so as to allow the interaction with a passive means of identification of the bracket 100 to receive the identification signal, and in response to the signal, change the operation mode of the electronic device 200 and/or change the settings of the electronic device 200; and the said bracket 100 is fixed on a vertical surface with the formation of the protrusion that can be placed in the recess 202 facing vertical surface side of the electronic device 200; wherein the protrusion comprises at least one ferromagnetic or magnetic element 101 and the recess 202 comprises the corresponding opposing magnetic or ferromagnetic element 201 so that when placing the protrusion in the recess 202, the magnetic connection is formed; and the recess 202 is formed so as to provide the appropriate opposing shift of the ferromagnetic or magnetic element 201 relative to the corresponding magnetic or ferromagnetic element 101 of the bracket 100; the bracket 100 is equipped with a passive means of identification, and the electronic device 200 is provided with at least a reader 203, configured to interact with said means of identification; wherein the electronic device 200 also includes, at least a processor 204; memory 205 that contains at least the program code, which when executed by the processor, provides the interaction of the mentioned reader with the means of identification to receive identification signal.

The present description of the claimed invention implementation demonstrates only particular embodiments and does not limit other embodiments of the claimed invention, since possible alternative embodiments of the claimed invention that do not go beyond the scope of information specified in this application should be obvious to a specialist in this field of technology with the usual qualifications for whom the claimed invention is designed.

1. An electronic device placed on a vertical surface and controlled by means of a bracket, containing, at least, a reader designed to interact with a passive means of identification of the bracket, a processor, a memory containing at least a program code, which, when executed by the processor, ensures interaction of the reader with the passive means of identification to receive an identification signal; wherein, the electronic device is designed to be placed on a vertical surface using a bracket; wherein, a recess is made in a side of the electronic device facing the vertical surface for a protrusion formed by the bracket; wherein, the bracket for the electronic device placed on the vertical surface is an element fixed on a vertical surface forming the protrusion that can be placed in a recess facing the vertical surface of the side of the electronic device; wherein, the protrusion contains at least one ferromagnetic or magnetic element, and a corresponding opposing magnetic or ferromagnetic element is placed in the recess in such a way that, when placing the protrusion in the recess, it contacts the corresponding ferromagnetic or magnetic element of the bracket to form a magnetic connection; wherein, the recess is made in such a way as to ensure shifting of the corresponding opposing magnetic or ferromagnetic element relative to the corresponding ferromagnetic or magnetic element.

2. The device according to claim 1, characterized in that the electronic device is an acoustic device containing additionally, at least, a processor-controlled audio output device.

3. The device according to claim 1, characterized in that the electronic device is a lighting device containing, additionally, at least, a processor-controlled light source.

4. The device according to claim 1, characterized in that the electronic device is an IoT device containing additionally, at least, a processor-controlled receiver, and a processor-controlled transmitter able to send a control signal.

5. The device according to claim 1, characterized in that the electronic device is an image output device containing additionally, at least, a processor-controlled display.

6. The device according to claim 1, characterized in that the memory additionally contains at least a program code, which, when executed by the processor ensures change of an operating mode of the electronic device and/or ensures change of settings of the electronic device in response to the received identification signal.

7. The device according to claim 2, characterized in that the memory additionally contains at least a program code, which, when executed by the processor ensures change of an operating mode of the electronic device and/or ensures change of settings of the electronic device in response to the received identification signal.

8. The device according to claim 3, characterized in that the memory additionally contains at least a program code, which, when executed by the processor ensures change of an operating mode of the electronic device and/or ensures change of settings of the electronic device in response to the received identification signal.

9. The device according to claim 4, characterized in that the memory additionally contains at least a program code, which, when executed by the processor ensures change of an operating mode of the electronic device and/or ensures change of settings of the electronic device in response to the received identification signal.

10. The device according to claim 5, characterized in that the memory additionally contains at least a program code, which, when executed by the processor ensures change of an operating mode of the electronic device and/or ensures change of settings of the electronic device in response to the received identification signal.
